(19) United States
(12) Patent Application Publication
(10) Pub. No.: US 2010/0044283 A1
(43) Pub. Date: Feb. 25, 2010

(54) Agricultural Product Conveyor and Sorting System

(76) Inventor: Danny Mitchell, Firth, ID (US)

Correspondence Address: KIRTON AND MCCONKIE, 60 EAST SOUTH TEMPLE,, SUITE 1800, SALT LAKE CITY, UT, 84111, US

(21) Appl. No.: 12/195,703

(22) Filed: Aug. 21, 2008

(51) Int. Cl. B07C 5/34

(52) U.S. Cl. 209/701

(57) ABSTRACT

The present invention relates generally to equipment utilized to sort agricultural products. Embodiments of the present invention utilize more than one roller bed in succession to progressively separate desired produce products from dirt, rocks, and undesirable biomass. Preferred embodiments comprise: a first pass roller system comprising a series of spaced rows of side-by-side sizing members extending transversely to the apparatus; a second pass roller system comprising a series of spaced rows of side-by-side sizing members extending transversely to the apparatus; a conveyor system for moving material which falls through the first and second pass roller systems to a third pass roller system comprising a series of spaced rows of side-by-side sizing members extending transversely to the apparatus.

### BACKGROUND

1. Field of the Invention

The present invention relates generally to equipment utilized to sort agricultural products, for example potatoes, onions and other similar vegetables and fruits. More specifically the present invention relates to an agricultural product conveyor and sorting systems capable of separating undersized agricultural products from waste material.

2. Background

Systems that convey and sort tuber and root produce are utilized extensively, and have been specifically designed to handle the particular types of problems inherent in transporting and sorting tuber and root produce. For example, a ubiquitous difficult faced when harvesting and sorting tuber and root produce is separating the marketable food products from dirt, rocks and other debris. Additional complexity is introduced if a given field is utilized to grow other cash crops in the off season. For example, it has become common for tubers to be grown in the same fields as other crops (e.g., corn). In some fields, once corn is harvested, potatoes are planted. The remnants of harvested corn, corn crowns, remain in the soil while the tubars grow. During the harvest of the tubars, the corn crowns are dug up. The process of sorting corn crowns has been accomplished primarily by manually sorting the crowns from the undersized tubars. This exposes workers to being injured by the large equipment being utilized to harvest the tubars. Additionally, root and tuber type sorting apparatus must be able to handle large loads of produce being sorted in a cost effective and efficient manner that not only removes the great bulk of the dirt, rock, and debris inherent in the harvesting of such roots and tubers, but also does not bruise the produce or damage it in any way that would affect its commercial value at the time of sale of such produce.

In a typical harvest, machinery is utilized. Typical prior art machinery utilize a hopper to hold food products exhumed from the earth. The harvested food product is in aggregate with dirt, rocks, and other undesirable biomass, including as mentioned previously corn crowns. The recently harvested produce is typically placed on a conveyor belt to be transported to the sorting location. Sorting equipment usually includes a series of rollers and fingers or tines that move the produce from the conveyor belt to the sorting rollers that separates produce of sufficient size from small produce, rocks dirt and undesirable biomass. The isolated, commercially viable food products are then moved on conveyors to be stored and sold. Typically, sorters operate on a principle of size exclusion, where there is sufficient space between the rollers to allow dirt, rocks and undesirable biomass to fall in the spaces between the rollers while the produce of sufficient size is retained. In some cases the undersized produce is manually sorted from undesirable biomass. Because the size and constitution of undesirable biomass (e.g., corn crowns), is similar to the undersized produce (e.g., small potatoes), machinery has not previously been developed that is capable of automatically sorting the undesirable biomass from the undersized produce. Once manually sorted the produce is transported to another series of rollers that further sort the produce according to size and weight, with the rejected matter removed. Finally, the produce is transported via storage conveyors to a holding bin or vehicle adjacent the sorting apparatus so that the produce can be taken to the proper storage facility or transport location from the field.

Manually sorting undesirable biomass from undersized produce requires workers to operate between the sorting equipment and the transport vehicles as the machinery moves in the fields, exposing workers to the potential of being injured by the moving machinery or transport vehicles. Unfortunately, although many of the problems inherent with sorting through root and tuber type produce have been overcome, there are still other problems that have yet to be eliminated. For example, and as previously noted, because undesirable biomass is manually sorted from undersized produce the efficiency of sorting is diminished, while concomitantly increasing the probability of injury in the field. Accordingly, what is needed is a produce sorting apparatus that is able to sort undesirable biomass from undersized produce automatically and efficiently without the need to manual sort the undesirable biomass from the undersized produce.

### SUMMARY OF THE INVENTION

The present invention relates generally to equipment utilized to sort agricultural products, for example potatoes, onions and other similar vegetables and fruits. Embodiments of the present invention utilize more than one roller bed in succession to progressively separate desired produce products from dirt, rocks, and undesirable biomass. Preferred embodiments comprise: a first pass roller system comprising a series of spaced rows of side-by-side sizing members extending transversely to the apparatus; a second pass roller system comprising a series of spaced rows of side-by-side sizing members extending transversely to the apparatus; a conveyor system for moving material, which falls through the first and second pass roller systems to a third pass roller system comprising a series of spaced rows of side-by-side sizing members extending transversely to the apparatus.

Some embodiments may further comprise a hopper located at a first end of the apparatus, a load conveyor belt for transporting material from the hopper to the first pass roller system, a hydraulic hopper elevator for adjusting the hopper, a decline transmission for moving material from the second roller system to a sorting tray or other storage device, and a return conveyor for carrying undersized produce, dirt, rocks and undesirable biomass to the third pass roller section or elimination device.

Some embodiments may utilize an adjustment mechanism to allow the space between individual rollers in a roller system to be adjusted. Other embodiments may comprise the use of a frequency drive, which may be utilized to automatically or manually control the rate that a conveyor or roller system moves, depending on the size of the load being processed.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a representation in perspective view of a complete potato sizing machine embodying a preferred embodiment of the sizing screen apparatus of the invention;

FIG. 2 is a representation of a side elevation view of a complete potato sizing machine embodying a preferred embodiment of the sizing apparatus of the invention; and

FIG. 3 is a top view of the rollers of an embodiment of the present invention.

### DETAILED DESCRIPTION OF THE PREFERRED EMBODIMENTS

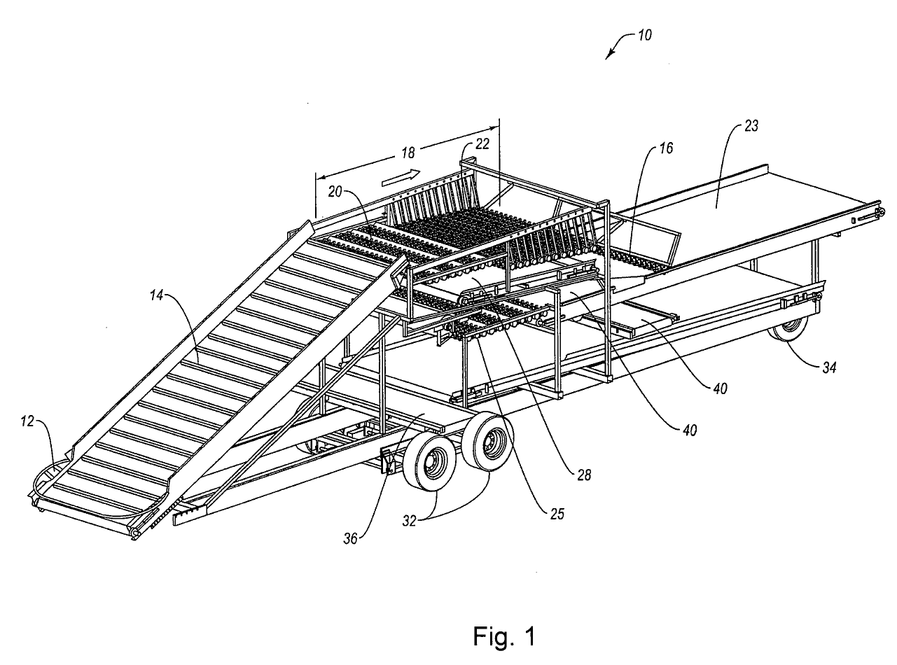

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 through 3, is not intended to limit the scope of the invention, as claimed, but is merely representative of embodiments of the invention. The specific embodiments of the invention will be best understood by reference to the drawings, wherein like parts are designated by like numerals throughout.

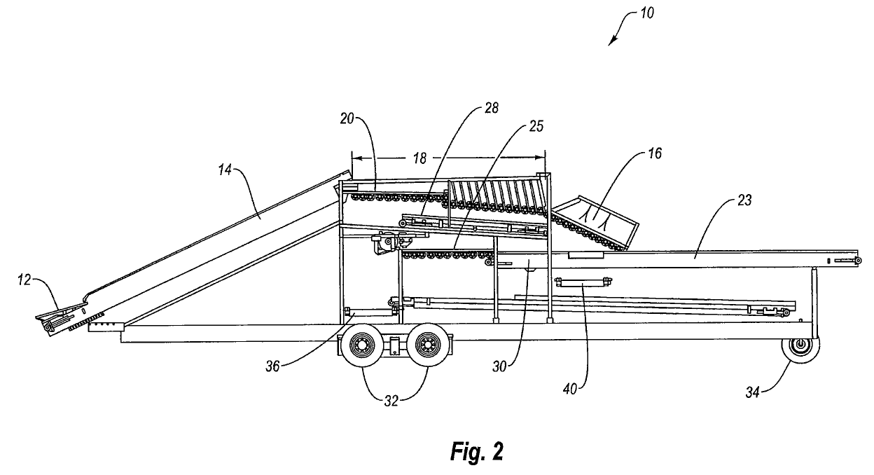

FIG. 1 and FIG. 2 illustrate a perspective view of a preferred embodiment of a sizing apparatus 10 in accordance with the present invention. The apparatus 10 is useful in accepting a load of produce, such as root or tuber type vegetables. Prior to sorting, the produce exists in aggregate with debris, under sized produce and undesirable biomass, which must be removed during the sorting process. It is also possible that the produce sorting and conveyor apparatus 10 can be used to sort other types of produce and other types of non-produce items that have a uniform size and shape to them, but need to be sorted and conveyed for storage or transport. Preferred embodiments of apparatus 10 may include a hopper 12 located at a first end and may further include a load conveyor 14. Load conveyor 14 typically is an endless loop conveyor belt or chain. Hopper 12 may further include a hydraulic hopper elevator (not shown), which is useful in elevating hopper 12 during operation to optimize the transport of produce from the conveyor through the apparatus 10. Load conveyor 14 transports the produce to a roller bed 18, which comprises a first pass roller section 20 and a second pass roller section 22.

First pass roller section 20 includes a plurality of rollers. One type of suitable roller is described in commonly assigned U.S. Pat. No. 6,241,100 Laterally Reinforced Produce Roller, filed Aug. 31, 1999, incorporated herein by reference for all purposes, which discloses a set of rollers typically utilized in a sorting and conveyor apparatus such as that of apparatus 10 of the present invention.

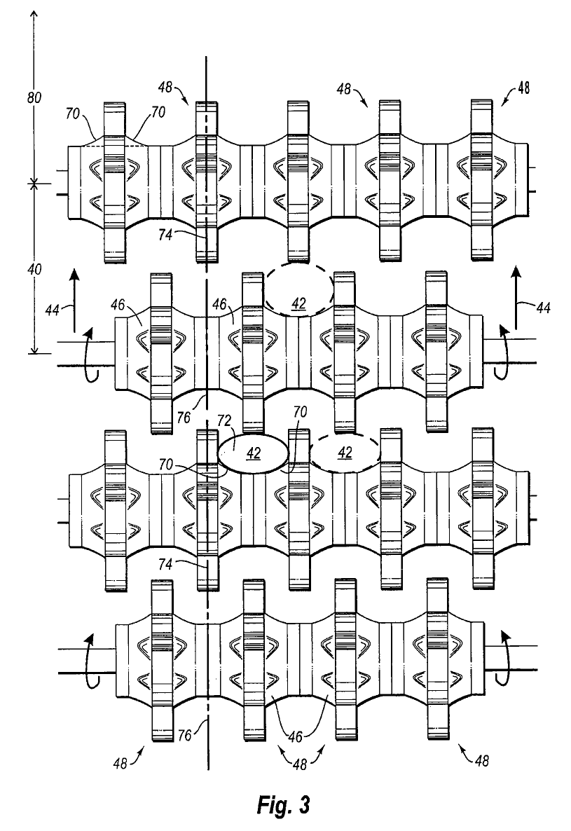

FIG. 3 illustrates a roller system utilized in preferred embodiments of the present invention. As depicted in FIG. 3 some embodiments of the present invention comprise a bed of produce grading rollers 6. A series of adjacent rollers may be arranged on a shaft. Propulsion fingers 48 propel produce along a grading path 44. Appropriately sized material will fall through an opening 42. In order to drive a series of rollers 6, a shaft 62 is placed through a series of adjacent rollers and connected to a rotating apparatus. Shoulders of individual rollers may comprise a concave outer surface 70, which gives shoulders proper lateral rigidity and defines an improved grading opening shape 42. Concave outer surfaces 70 form a substantially half oval shape 72 for opening 42 which better approximates the shape of a potato or other round or oblong produce. This shape 72 provides more uniform grading as produce fits snugly into the opening without twisting or wedging into opening corners as in prior art openings. When produce which is slightly larger than opening 42 falls onto openings it is summarily ejected by fingers 48 on rollers found on the next successive roller shaft. Fingers on these rollers will positively engage oversize produce and propel it to the next grading opening 42.

The rollers found in first pass roller section 20 are of a first size that typically allows the larger produce items to pass over without falling between the slits and openings that are formed within the bank of rollers of section 20. In preferred embodiments, this first section allows for dirt, rocks, small produce and undesirable biomass to filter through the openings of roller section 20, where they are deposited onto the return conveyor 28. Similarly, the rollers found in the second pass roller section 22 are of a size that typically allows the larger produce items to pass over without falling between the slits and openings that are formed within the bank of rollers of section 22. In preferred embodiments, the second section allows for any remaining dirt rocks, small produce and undesirable biomass to filter through the openings of roller section 20, where they are deposited onto the return conveyor 28. In preferred embodiments, the combination of sections 20 and 22 effectively separate away 100% of the dirt, rocks, small produce and undesirable biomass from the larger produce which moves to the decline transmission 16.

In preferred embodiments, roller bed 18 may comprise an adjustment mechanism (not shown) that allows the spacing between transversely extending, individual rows of rollers 6, to be adjusted individually. Accordingly, in preferred embodiments the space between individual rollers 6 on both banks of rollers 20 and 22 may be individually adjusted to allow selected sized produce to pass along the top of the roller bed 18 and to the decline transmission. Size selection may depend on various factors including the type or run of tubers being harvested.

The decline transmission 16 may comprise any form which allows the larger produce to move to the sorting tray 23. In preferred embodiments the decline transmission 16 is comprised of a suitable roller as described in commonly assigned U.S. Pat. No. 6,241,100 Laterally Reinforced Produce Roller, filed Aug. 31, 1999, incorporated by reference for all purposes, which discloses a set of rollers typically, utilized in a sorting and conveyor apparatus such as that of apparatus 10 of the present invention. However, the present invention contemplates utilizing an apron, belt or other means known in the art.

Roller sections 20 and 22 are coupled to a motor (not shown), which is utilized to drive the rollers in the direction pointed by the arrow in FIG. 1. The dirt, debris, small produce, and undesirable biomass that falls between the rollers in sections 20 and 22 may be carried back to a third pass roller section 25 by a return conveyor belt 28. Next, the produce that remains and has not fallen through the openings in the first roller section 20, then passes through the second roller section 22. Roller section 22 removes the remaining unwanted debris, including dirt, rocks, small produce and undesirable biomass, that failed to pass through the first roller section 20. This refuse may be carried back to a third pass roller section 25 by a return conveyor belt 28 which is situated below roller bed 18. The produce that successfully passes over the roller bed 18 and descends the decline transmission 16, is subsequently deposited upon sorting tray 23. Apparatus 10 is also designed to be mobile, or at least transportable through the crop field, and hence, lead tires 32 and rear tires 34 are provided to support apparatus 10 and allow it to be transported over most terrain.

In preferred embodiments, once produce has been effectively screened by roller sections 20 and 22, 100% of the dirt, rocks, undersized produce and undesirable bio mass is dropped from the roller bed 18 onto the return conveyor 28. Accordingly, in preferred embodiments, the produce that passes over the top of the roller bed 18 onto the decline transmission 16 consists entirely of larger produce, which subsequently moves to the sorting tray 23. The return conveyor 28 moves the dirt, rocks, undersized produce and undesirable biomass to the third pass roller section 25.

Large loads of produce may be deposited into the hopper 12, resulting in large amounts of dirt, rocks, undersized produce and undesirable biomass being dropped through roller sections 20 and 22 onto the return conveyor 28. When this large portion of material is placed on the return conveyor 28, a large pile of produce and material is transported on the conveyor into the third pass rollers 25. This large quantity of matter may forms multiple layers of debris and undersized produce on the rollers third pass rollers 25 which cannot be sorted effectively. One solution to this problem was effectively proposed by commonly assigned U.S. Pat. No. 6,621,014 Load Sensitive, Variable Speed Mechanical Dynamics Adjusting System, filed Oct. 13, 2000, incorporated herein by reference for all purposes, which provides a system that dynamically adjusts to a given load ensuring that a single uniform layer of produce pass across the rollers. Accordingly, in preferred embodiments of the present invention a variable speed mechanism is utilized to ensure that undersized produce and unwanted debris pass in a single uniform layer across the third pass roller section allowing unwanted debris, including dirt rocks and undesirable biomass (e.g., corn crowns) to be disposed of through the gaps in the rollers of the third pass roller section 25.

In preferred embodiments, the present invention incorporates a load sensing mechanism which signals to a control unit a particular load weight. The control unit calculates the optimal speed for processing that amount of load and varies the speed of the motor or motors that actuate the translocation of the load. When no load is sensed, the entire unit can be switched off. When an above-normal load is sensed, speeds are adjusted accordingly to accommodate the increased load. This load sensitivity allows the load to be processed with the greatest amount of consistency and efficiency. Preferred embodiments of the present invention may feature a load sensitive, mechanical dynamics adjusting system comprising a) a load receiving member for receiving a load at a first point; b) at least one load translocator for moving the load from a first point to at least a second point, the load translocator comprising at least one mechanical load moving device coupled to a variable speed motor; c) a load sensing device coupled to the load receiving member, the load sensing device capable of sensing a load weight and transmitting a signal corresponding to the load weight; and d) a control unit electrically connected to the load sensing device, the control unit receiving and calculating the signal corresponding to the load weight as transmitted by the load sensing device, and adjusting the variable speed motor as needed, thus adjusting the speed of the at least one load translocator.

Third pass roller section 25 includes a plurality of rollers. One type of suitable roller is described in commonly assigned U.S. Pat. No. 6,241,100 laterally reinforced produce roller, filed Aug. 31, 1999, incorporated by reference for all purposes, which disclose a set a rollers typically utilized in a sorting and conveyor apparatus such as that of apparatus 10 of the present invention. The rollers found in the third pass roller section 25 are of a size that typically allows the undersized produce items to pass over without falling between the slits and openings that are formed within the bank of rollers of section 25. This third pass section allows for dirt, rocks, small and undesirable biomass to filter through the openings of roller section 25, where they are deposited onto a first cross conveyor 36. The third roller section 25 effectively moves undersized produce in a direction towards the sorting tray 23. As undersized produce moves along the third pass roller section 25 effectively all of the remaining dirt, rocks and undesirable biomass, including corn crowns, are dropped onto the cross conveyor 36. The unwanted debris dropped onto cross conveyor 36 may be disposed of, while the undersized produce carried along the top of the third pass roller section 25 is transported to the conveyor system 23. Once on the conveyor system 23 the undersized may be allowed either to move on the conveyor system to the sorting tray 23 or alternatively be routed by routing wings or dividing shears 38 and disposed on the second cross conveyor 40. If allowed to proceed along the conveyor system 23 to the sorting tray 23 all of the produce harvested including large produce and undersized produce are deposited into the sorting tray 23. However, in certain situations it is desirable to segregate the large produce from the undersized clean produce. In these situations, it may be preferable, to allow undersized produce to fall from the conveyor system 23 to the second cross conveyor 40 where undersized produce may be collected, and processed independently from the large produce.

The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A mechanical system for sorting produce comprising:
a first pass roller system;
a second pass roller system;
a conveyor system for moving material which falls through the first and second pass roller systems to a third pass roller system.

2. The mechanical system of claim 1, wherein the first pass roller system and second pass roller system effectively remove a preselected size of produce to be completely segregated from an aggregate of dirt, rocks and variable sized produce.

3. The mechanical system of claim 1, wherein the third pass roller system effectively isolates undersized produce from aggregate dirt, rocks and variable sized produce.

4. The mechanical system of claim 1, wherein the first pass roller system further comprises and adjustment mechanism for adjusting the space between rollers.

5. The mechanical system of claim 1, further comprising a hopper.

6. The mechanical system as in claim 1, further comprising a load conveyor.

7. The mechanical system of claim 1, further comprising a decline transmission.

8. The mechanical system of claim 1, further comprising a return conveyor for carrying undersized produce, dirt, rocks and undesirable biomass to the third pass roller system.

9. The mechanical system of claim 1, further comprising a sorting tray.

10. The mechanical system of claim 1, further comprising a conveyor system for carrying large produce from the decline transmission and undersized produce from the third pass roller system.

11. The mechanical system of claim 1, further comprising a cross conveyor for moving remaining dirt, rocks and undesirable biomass which has fallen from the third pass roller system.

12. The mechanical system of claim 1, further comprising a second cross conveyor for moving undersized produce.

13. A method for sorting produce comprising:
moving produce, dirt, rocks and undesirable biomass across a first pass roller system;
allowing undersized produce, dirt, rocks and undesirable biomass to fall through the first pass roller system;
moving produce, dirt, rocks and undesirable biomass, which remained on top of first pass roller system, across a second pass roller system;
allowing all remaining undersized produce, dirt, rocks and undesirable biomass to fall through the second pass roller system;
moving all material, which has fallen through the first and second pass roller systems, across a third pass roller system; and
allowing all dirt, rocks and undesirable biomass to fall through the third pass roller system.

14. The method of claim 13, further comprising the step of manually adjusting the space between rollers on one of a first pass roller system, a second roller pass system and a third pass roller system.

15. The method of claim 13, further comprising the step of automatically adjusting the space between rollers on one of a first pass roller system, a second roller pass system and a third pass roller system.

16. The method of claim 13, further comprising an initial step of placing a load of produce, dirt, rocks and undesirable biomass in a hopper.

17. The method of claim 16, further comprising the step of conveying the load of produce, dirt, rocks and undesirable biomass from the hopper to a first pass roller system.

18. The method of claim 1, further comprising the step of conveying undersized produce, dirt, rocks and undesirable biomass, which have fallen through the first and second pass roller systems, to the third pass roller system.

19. The method of claim 1, further comprising the step of conveying produce to sorting tray after moving across the top of the first and second pass roller systems.
